(19) United States
(12) Patent Application Publication
(10) Pub. No.: US 2004/0255142 A1
(43) Pub. Date: Dec. 16, 2004

(54) Bardachenko method for object access identification and for information input using changeable tag number

(76) Inventor: Vitaly Bardachenko, Kiev (UA)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/432,327

(22) PCT Filed: Nov. 21, 2001
(86) PCT No.: PCT/UA01/00046

(30) Foreign Application Priority Data
Nov. 22, 2000 (UA) 2000116602

(51) Int. Cl. H04L 9/00; H04L 9/32

(52) U.S. Cl. 713/200

(57) ABSTRACT

The invention relates to information carriers provided with control devices, more specifically to methods for identifying and inputting information, recognising access to various objects and marking infed information. The inventive method improves the use of an identifier for memorising (storing) or accelerated dialling by introducing practices which provide an independence of the information conditions of one part of tag numbers from the information state of other part thereof. Said independence is a result of an additional periodical tag number modification by means of the uniform opening (closing) of the part of tag numbers (marks) during an in-line dialling by an optional rotation of tag numbered elements with the aid of the identifier.

### TECHNICAL AREA

The invention is relevant to the information storage media that work with controllers. More precisely, it is a method of identification and input of information that identifies the access rights to and labeling of input information. Such methods are subject to fairly contradictive requirements where simple methods and designs need to be combined with reliable data protection from unauthorized access.

### PRECEDING TECHNICAL DEVELOPMENT

Known is an identification method (“information input with variable marker” further omitted), that suggests a permanent code use (Hungarian patent No. 181176, published Dec. 31, 1984, 7/10). Reliability of this method is doubtful, especially in the event or identifier being lost, stolen, or copied.

Additionally, known is the method of object access identification which includes real time code input (dialing) on the identifier by selective rotation of its elements with code marks. (Patent of Ukraine No.85 for a useful model, published Oct. 31, 1997). This method is selected as prototype. This method substantially increases number of variants comparing to the previously described one. Known disadvantage of this method is that as the result of elements rotation code elements output new set of markers, with code values that differ from such values of the previous set of markers. Consequently, user is required to memorize and set the code in its-entirety on the identifier, despite the fact that the code may be inconveniently long.

### INVENTION DISCLOSURE

This invention is to improve convenience and reliability of code storing (memorizing) during it's input (dialing) into the identifier, which is achieved by implementing number of techniques to ensure independent state of information of one part (set) of markers in relations to another part.

The above task is achieved by additional periodical change to the code by reciprocate opening or closing of some part of code markers while inputting the code into the identifier by rotating (dialing) the elements with code marks. Additionally code is changed periodically by simultaneous opening or closing of some of the code marks.

Opening or closing of preferably about half of the code markers should be occurring in specially allocated area designated for periodic code change. This is to further improve convenience of use of identifier by preserving marker's closure elements, and most importantly to maximize variability of the input.

### BRIEF DESCRIPTION OF THE DRAWINGS

FIG. 1 shows axonometric view of the identifier.

FIG. 2 shows plates with code markers shaped as openings

FIG. 3 shows plates with code markers shaped as slots

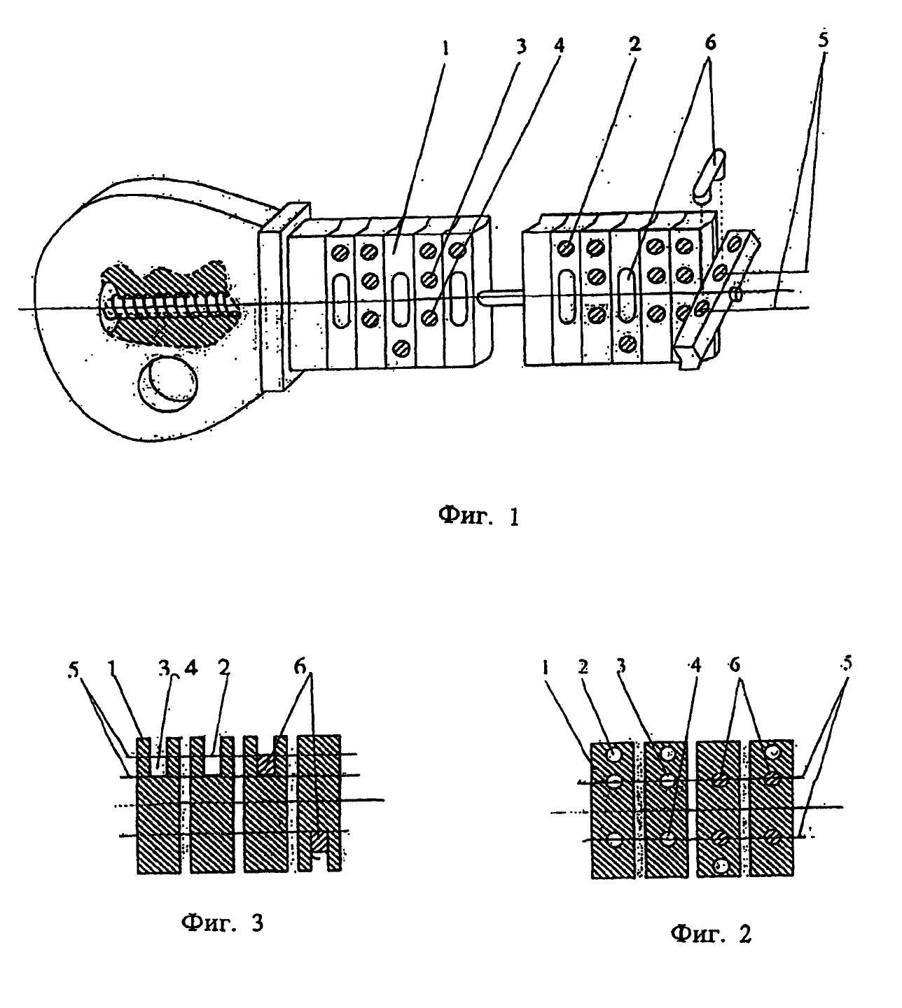

### EMBODIMENT OF INVENTION

Substance of invention is explained in the drawing of the identifier embodiment. Plates (1) of the identifiers contain code markers (2) and rotated selectively. Code values of the markers (2), that are located on the opposing surfaces of the plate (1) are different from each other, therefore plate rotation provides for rapid code change (where absence of the marker is also assigned a logical value). Additionally, part of the code created by markers (3) and (4) in area (5) of the identifier does not change its logical state. Unchanged state is due to the coinciding coordinates of markers (3) and (4) on the plate (1), and identical state either open or closed. Therefore, rotation of plate (1) does not change code state of markers as long as they are located on the reading line of area (5), because information (logical) state of <markers in this> area does not change, as a part of markers general code.

To change logical state of the area, which also changes the entire code, one need to alter code state of couple of markers on al least one plate. Such action is taken much less frequently than on-the-fly code change by plate rotation. Therefore, it is only necessary for user to memorize small portion of the code, which is both more convenient and reliable. Another advantage is that in the rush situations it may allow for faster code input.

To achieve maximum variability of the information state in the area, it is only necessary to change (preferably) just over half of the markers in the area. It also reduces wear of the closing elements (6), due to reduction in their use and that they do not have to be stored separately from the identifier, since they are always inserted in some plates.

In case that identifier consists of only 10 plates, the proposed method offers following variability: 1024 variants as the result of plates rotations, and 252 additional variants as a result of reallocation of 5 closing elements of half (6) of total number of pairs.

Accordingly, the total variability of the set is 258 thousand, which is fully sufficient for reliable protection of various types of information objects.

Above identifier design is based on rotating plates with two blades or one where code elements are triangular, square or so <n-polygons>-shaped. In such a design version periodical changes will be occurring to triads, quads, and so on, rather the pairs, which further increases input variability.

Reading of the code information may be implemented optically, magnetically, mechanically or by other means. Most convenient optical method represents markers as light openings, and their closing elements (6) are brackets. If mechanical method is chosen, markers may be represented by the larger or smaller depth or width code grooves on the plates, or change in thickness or shape of the plate, or similar changes. Change of code in area 5 will be implemented in each case by change of the corresponding plate parameter.

Hence the above method ensures both reliability and convenience in identifies use, and provides for sufficient speed and variability of the code input.

1. Bardachenko method of rights identification for access to information is based on code input with variable marker, which includes real time input into identifier by selective rotation of its elements bearing code markers, different in the sense that code is additionally changed by simultaneous opening or closure of some part of code markers in the identifier.

2. Identification method as in 1, different in that on rotating elements there is an area selected for periodic code change, where part of code markers are closer or opened.
